(19) United States
(12) Patent Application Publication
(10) Pub. No.: US 2013/0304646 A1
(43) Pub. Date: Nov. 14, 2013

(54) METHOD AND SYSTEM FOR IDENTITY AND KNOW YOUR CUSTOMER VERIFICATION THROUGH CREDIT CARD TRANSACTIONS IN COMBINATION WITH INTERNET BASED SOCIAL DATA

(71) Applicant: Jacob de Geer, Stockholm (SE)

(72) Inventor: Jacob de Geer, Stockholm (SE)

(73) Assignee: IZETTLE HARDWARE AB, Stockholm (SE)

(21) Appl. No.: 13/470,737

(22) Filed: May 14, 2012

(51) Int. Cl. G06Q 20/16

(52) U.S. Cl. 705/44

(57) ABSTRACT

A method and system for verifying an identity of a card holder associated with a payment card using a payment device comprising a card reader and a mobile device. The method comprising the steps of initiating verification of identity of the card holder by inserting the payment card in the card reader of the payment device, reading card information from the payment card communicating the card information from the mobile device to a payment server, comparing received card information with stored card information in the payment server and accessing at least one web service. The account activity is analysed in the at least one web service and in that way verifying that the identity of the card holder is the same as the identity associated with the payment card, based on the analysis of information from the at least one web service and from the comparison of card information with stored card information. Terminating the verification process by communicating the result of the verification process from the payment server to the payment device.

### TECHNICAL FIELD

The invention relates in general to the field of electronic payment card transactions, and more particularly, to a method and a system for performing an electronic ‘know your customer’ process for verifying and connecting an identity of a company or an individual to a specific electronic payment card.

### BACKGROUND

Every day an incredible number of debit and credit card payments are made around the world, and the number of payments are steadily increasing. In order to avoid debit or credit card fraud it is important to have methods for verifying the identity of one or more of the parties involved in a payment transaction and also their right to make and/or receive a payment transaction. It is also important that the verification can be performed swiftly and reliable in order to avoid unnecessary waiting time.

In many countries there is no standard and/or reliable way to electronically verify a person's identity. In these cases the payment service provider needs to “know its customer” in order to verify the identity of the customer. The term ‘Know Your Customer’ (KYC) is widely used in the financial world and relates to both to activities of customer due diligence that financial institutions and other regulated companies must perform to identify their clients and ascertain relevant information pertinent to doing financial business with them, as well as the bank regulation which governs those activities. The abbreviation KYC is used in both senses through out the applications.

The payment provider's customers, i.e. the merchants, often include both companies and individuals. There are well-established international agreed methods for performing KYC on companies, but for individuals there is no standard and/or secure method that can be applied all over the world.

For example, in the Nordic countries it is easy to verify the identity of any person or company through various services such as UC (www.uc.se) thanks to the use of social security numbers. However, in many countries outside the Nordic countries there are no such services available to a payment provider, which makes it problematic to accept individuals as customers through, for instance, an online customer verification process.

The electronic KYC process is currently limited to a solution where an Individual (a merchant) makes a micro payment from his/her bank account to a bank account controlled or trusted by the payment provider. By doing so, the payment provider is able to validate the merchant's identity, for instance by the merchant's name, from the bank were the money was transferred from. The merchant's name is then crosschecked with the name stated by the merchant during the sign-up of the payment provider's service. In some cases, where available, the merchant's name may also be crosschecked against third party databases (e.g. UC or Dun and Bradstreet). However, currently there are very few reliable electronic databases that enable payment providers to check the name received from a micro transaction.

Also, the current process used by banks to validate an individuals identity is very “manual” in the sense that a person needs to visit, in person, his/her bank, show a passport, a copy of an electrical bill et c in order to provide enough proof that he/she is who they claim to be to open an account. This manual process is very cumbersome and requires a lot of administration, both for the customer and for the bank.

Hence it is very cumbersome and difficult to create a reliable and fully electronic KYC process. The effect is often increased lead-times and a higher degree of risk/fraud to approve a new customer as well as a dramatic increase in cost per new customer. Thus, finding a way to provide a reliable, efficient and fully electronic KYC process that can be used around the world for both companies and individuals are highly sought after.

### SUMMARY OF THE INVENTION

With the above description in mind, then, an aspect of the present invention is to provide a way to perform an electronic KYC process which seeks to mitigate, alleviate, or eliminate one or more of the above-identified deficiencies in the art and disadvantages singly or in any combination.

A first aspect of the present invention relates to a method for verifying an identity of a card holder associated with a payment card using a payment device comprising a card reader and a mobile device, the method comprising the steps, initiating verification of identity of said card holder by inserting said payment card in said card reader of said payment device, reading card information from said payment card, communicating said card information from said mobile device to a payment server, comparing received card information with stored card information in said payment server, accessing at least one web service, analyzing account activity in said at least one web service, verifying that the identity of the card holder is the same as the identity associated with the payment card based on said analysis of information from said at least one web service and from said comparison of card information with stored card information, and terminating said verification by communicating the result of the verification from said payment server to said payment device.

The method may further comprise the step of communicating an order for micropayment together with said card information from said mobile device to a payment server, communicating said order for micropayment to a bank server, verifying said order for micropayment in said bank server, expediting said micropayment in said bank server, and communicating a receipt and an account name to said payment server.

The method may further comprise the step of comparing the received account name with the stored card information in said payment server and basing said verification of identity of the card holder on said comparison of the received account name with the stored card information.

The method may further comprise the step of determining if said payment card is legit by reading card information, wherein if said reading fails the verifying is terminated.

The method may further comprise the step of encrypting said card information before communicating it to said payment server and decrypted said encrypted card information in said payment server.

The method may further comprise the step of encrypting said order for micropayment before communicating it to said payment server and decrypted said order for micropayment in said payment server or in said bank server.

The method wherein said card information may be the name of the card holder stored encrypted in said payment card.

The method wherein said card information may be pre-stored in said payment server from a previous verification or a registration from when the card holder firstly subscribed to the payment service offered by the payment provider.

The method wherein said order for micropayment may comprise at least an account number and amount.

The method may further comprise the step of communicating a receipt to said payment device sating if said card holders identity is determined to verified or not.

A second aspect of the present invention relates to a payment system for verification of an identity of a card holder associated with a payment card, the system comprising a payment device comprising a card reader and a mobile device, a payment server, a bank server and wherein said payment system is configured to perform the steps of the first aspect above.

### BRIEF DESCRIPTION OF THE DRAWINGS

Further objects, features, and advantages of the present invention will appear from the following detailed description of some embodiments of the invention, wherein some embodiments of the invention will be described in more detail with reference to the accompanying drawings, in which:

FIG. 1 shows a mobile phone for conducting PIN authorized EMV payments, according to an embodiment of the present invention; and

FIG. 2 shows a block diagram of a system for performing the electronic know your customer process; and

FIG. 3a shows a flow chart describing the electronic know your customer process, according to an embodiment of the present invention; and

FIG. 3b shows a flow chart describing another aspect of the electronic know your customer process, according to an embodiment of the present invention.

### DETAILED DESCRIPTION

Embodiments of the present invention will be described in detail hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference signs refer to like elements throughout.

Embodiments of the present invention will be exemplified using a mobile communication device such as a mobile phone. However, it should be appreciated that the invention is as such equally applicable to electronic devices which have wired- and/or wireless radio communication capabilities. Examples of such devices may for instance be any type of mobile phone, laptop (such as standard, ultra portables, netbooks, and micro laptops) handheld computer, portable digital assistant, tablet computer, gaming device, accessories to mobile phones, mobile or stationary card payment terminals, etc. However, for the sake of clarity and simplicity, the embodiments outlined in this specification are exemplified with, and related to, mobile phones only.

The present invention provides a secure, reliable, efficient and fully electronic KYC verification process, which can be used around the world to verify the identity of companies as well as individuals. The electronic KYC verification process is based on a secure debit and credit card payment system, disclosed and described in detail in the international patent application with the application number PCT/EP2010/066186 which hereby is incorporated in its entire into this application for reference.

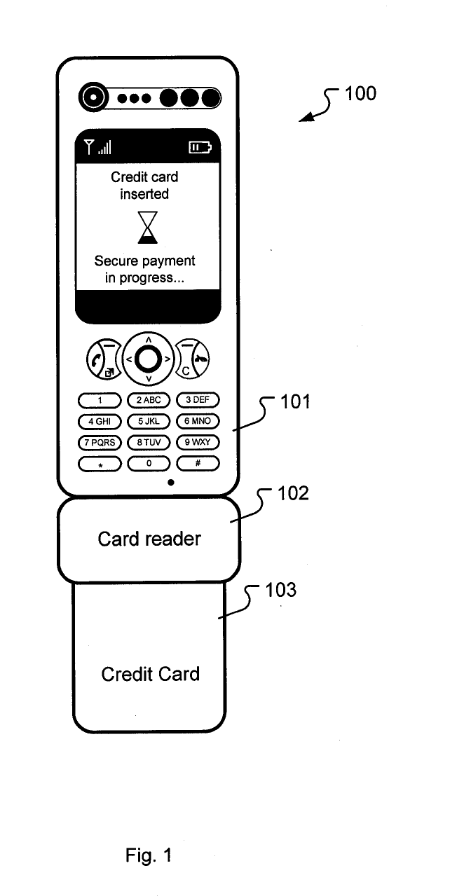

The electronic KYC verification process, according to an embodiment of the present invention, may be implemented using a payment device 100. An example of such a payment device 100 is shown in FIG. 1. The payment device 100 comprises of, but not limited to, an ordinary unsecure mobile phone 101 having a screen for conveying visual information to the user and input means, here exemplified by physical buttons but may also be in the form of soft buttons in a touch sensitive display, for the user to input information such as for instance payment information. The mobile phone 101 may further have processing means (not shown), for running secure applications, communication means (not shown) for connecting to other mobile communication devices and/or the Internet, either by wire or wirelessly, and an interface for connecting peripheral devices such as a card reader device. When performing a payment/transaction/task a card reader device 102 is connected to the mobile phone and a debit or a credit card 103 is inserted into the card reader device 102. During operations the card reader device 102 uses the mobile phone 101 primarily as a modem for communicating with a payment server, via a communications network, for handling the payment transaction and a user interface for input of requested information. The secure information read from the debit or credit card 103 may (or may not) be encrypted by the card reader 102 before it is transmitted by the unsecure mobile phone 101 to a payment server. In this way the card reader device and the payment server may securely communicate with each other.

From hereinafter credit cards, debit cards or any other type of electronic cards that may be used and/or functions as a debit or credit card is referred to as a payment card. The term payment card may also include a piece of software that acts as a debit or credit card, or a computer based service that acts as a debit or credit card. The term payment card may also apply to debit and credit cards without a secure chipset (EMV chipset), where information instead is stored in a magnetic stripe.

The invention, which will be described in more detail below, enables the payment provider, to verify that information stored on the payment card 201, such as the card holder's name, corresponds to the information associated to the bank account, such as the name of the owner of the bank account, connected to the payment card, and also verifying that the car holder's identity is legit by comparing data from a variety of web sources such as available Internet based social services. The invention will thus make it possible for the payment provider to verify the person's identity, and thus ‘know its customer’.

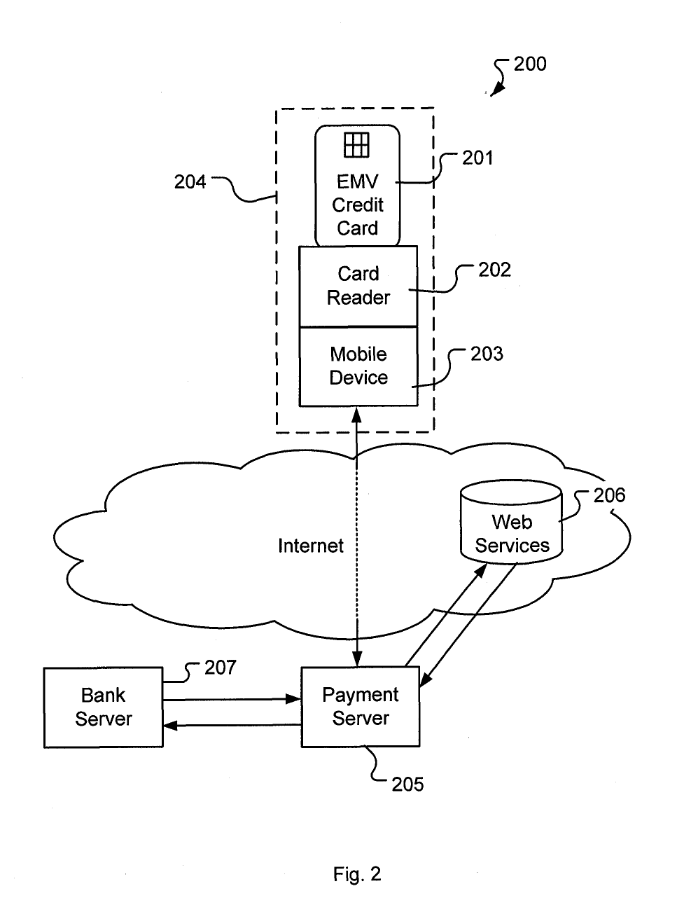

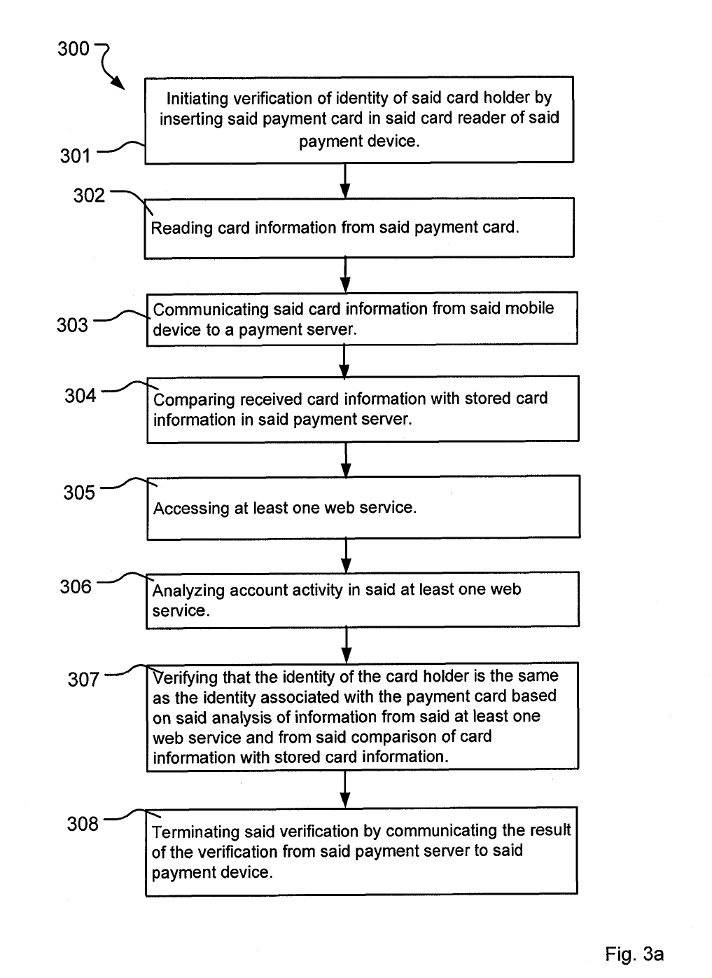

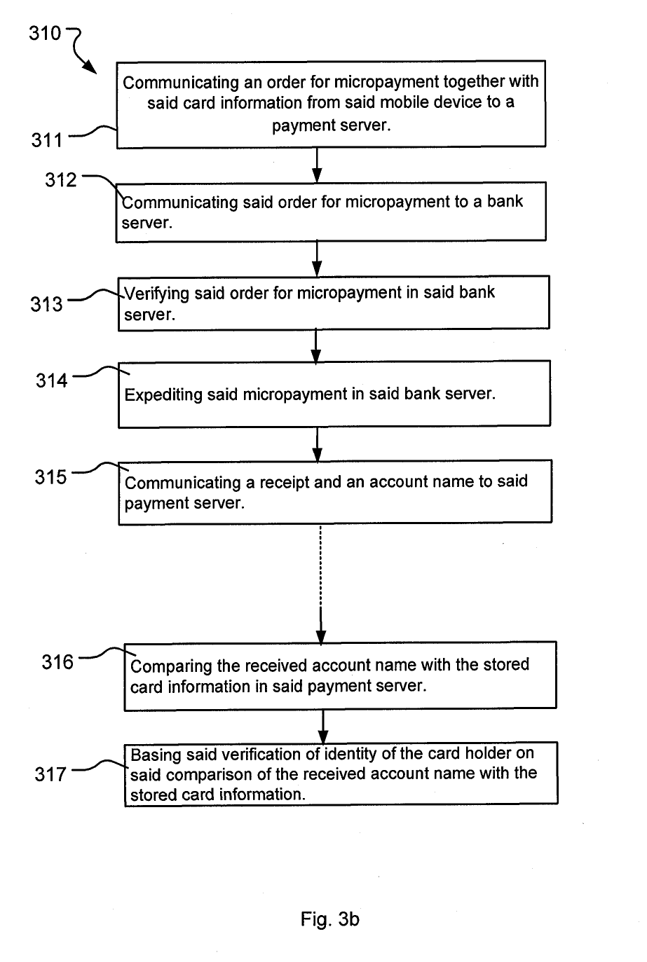

FIG. 2 shows a block diagram of a KYC verification system 200 for performing an electronic KYC verification process, from hereinafter referred to as the verification process, according to an embodiment of the present invention. FIGS. 3a and 3b shows two flow charts 300,310 describing embodiments of the present invention for performing said verification process in said verification system 200.

The verification process is initiated 301 when the card holder, which may be the merchant or a private person, inserts the payment card, into the card reader 202 attached to the payment device 204. The card reader 202 reads the card information 302 stored in the chip of the payment card 201. If the read of the card information fails the payment card may either be invalid (not legit) or broken (for instance having oxidized contact). If the read fails an error message will be presented on the display of the mobile device 203, and the verification process will be terminated.

The card information comprises information about the card holder and the payment card such as the name and/or any other information (such as address, social security number, etc.) which may be used to identify the card holder associated with the payment card. For simplicity, the verification process will be described using the ‘name’-information. However, it should be understood that any available card information may be used in the verification process singularly or in any combination with each other for performing the same verification process as will be described below.

The read name from the payment card is in an embodiment of the present invention encrypted and communicated from the card reader 202, via the unsecure mobile phone 203, in the payment device 204 to a payment server 205.

In another variant the read name from the payment card is encrypted and communicated together with an order for a micropayment (a full EMV payment) 310 to the payment server 205. The order for micropayment may include information such as bank account number and the amount to be paid in the micropayment. The amount to be paid may be decided by or preset by the payment provider or it may be entered via the user interface on the mobile phone 203 by the person operating the payment device 204. The amount to be paid in a micropayment is in most cases a small amount such as 0.10 Euro or 0.10 USD (in 2012 year's currency) or another similar amount in any currency. However, if the card holder is carrying out the verification process for the first time the order for a micropayment may alternatively be a larger amount.

In an embodiment of the present invention the communicated 303 name from the payment device 204 is received at the payment server 205, and decrypted and compared 304 to previously stored information in the payment server about the card holder. In this way the card holder, using his/hers payment card 201 in the payment device 204 may be verified against information, in this case the name information, already stored in the payment server. The stored information in the payment server 205 may come from a previous verification process wherein the communicated name information has been stored in the payment server or it may come from some kind of registration process from when the card holder firstly subscribed or bought to the payment service offered by the payment provider. If the stored name information is determined to be the same as the communicated name from the payment device 204, then the identity if the card holder using the payment device 204 with a payment card 201 is determined to be verified. Thus, the identity of the card holder is verified to be the same as the identity associated with the payment card, and a recipe communicating that the verification process turned out ok may optionally be sent to the payment device 204 and displayed on the display of the mobile phone 203. The verification process is then terminated. If the verification fails due to the fact that the stored name information is determined not to be the same as the communicated name from the payment device 204, a recipe communicating that the verification failed may optionally be sent to the payment device 204 and displayed on the display of the mobile phone 203. The verification process is then terminated.

In another embodiment of the present invention the communicated name and order for micropayment from the payment device 204 to the payment server 205 is decrypted, and the ‘name’-information is compared to previously stored information in the payment server 205 about the card holder. The order for micropayment is communicated 312, preferably in an encrypted fashion, to payment provider's bank server 207. The bank server 207 verifies 313 the micropayment (by for instance verifying that the account number is correct and that the amount that is to be paid is present in the account) and expedites the payment 314. The amount stated in the micropayment is transferred from the card holder's bank account to the payment provider's bank account by the bank server 207. Information regarding that the payment has been completed and the name of the company or person owning the account from which the micropayment has been paid to the payment provider's bank account is communicated from the bank server 207 to the payment server 205 and associated (or compared) with information in the ongoing verification process based on a transaction ID-number, a unique code, the card holder's user name at the payment provider or similar data that can connect the transaction information to the ongoing verification process. In this way the micropayment is able to verify that the account exists and that it is not closed, black listed or blocked in any way. The bank server 207 will generate a receipt stating that the micropayment was successful and communicate 315 the recipe together with the name of the owner of the account associated with the bank account from where the micro payment was expedited. The name received from the micropayment is then compared 316 with the name received from the chipset on the credit card in the payment server 205. If the name received from the micropayment is determined 317 to be the same as the received from the chipset on the credit card in the payment server 205, then the identity if the card holder using the payment device 204 with a payment card 201 is determined to be verified. Thus, the identity of the card holder is verified to be the same as the identity associated with the payment card, and a recipe communicating that the verification process turned out ok may optionally be sent to the payment device 204 and displayed on the display of the mobile phone 203. The verification process is then terminated. If the verification fails due to the fact that the name received from the micropayment is determined not to be the same as the received from the chipset on the credit card in the payment server 205, a recipe communicating that the verification failed may optionally be sent to the payment device 204 and displayed on the display of the mobile phone 203. The verification process is then terminated.

If the verification process fails the card holder is blocked from using the payment system 200 and/or the payment card 201, and the verification process is terminated by sending the result of the verification process to the payment device 204.

To further strengthen the verification process, and especially to verify that the identity of the card holder is a valid (living) person and not just a front created with the intent to commit fraud, the read card information may be compared to other available information accessible from web services 206 on the Internet. A web service 206 may be located on one or more physical web server connected to the Internet. The payment server 205 may access one or more web service 206, 305 (which may for instance be pre-approved web services by the payment provider) on the Internet extracting and analyzing available web information 306 (such as name, address, social security information, etc.), singularly or in combination with information about social activity (such as number of friend, time stamped activity in chats and Twitters or on blogs, etc.) of the card holder (hereinafter collectively referred to as activity information) in public or private web services 206.

In a variant the card holder may be asked to login to a web service such as Facebook anytime during the verification process (generally in the beginning of the verification process). The activity information in the Facebook account may then be used to further verify, in the payment server 205, that the card information read from the credit card belongs to a legit person. If any discrepancies are noted then the payment server 205 may act and either warns the payment provider by for instance flagging the verification process for manual verification and/or terminating the verification process.

The payment server 205 may also query either a general search or a dedicated search of the Internet to find web information that will support the identity of the card holder or not. The activity information gathered from one or more web services and/or the web information gathered from Internet may be used in several different ways when verifying the identity of the card holder 307. In one variant the activity information and/or the web information from the web services 206m and the Internet is only used as guidance to further strengthen the verification process but not for making the actual decision of in the verification process of if the person is legit or not. In another variant the activity information from the web services 206 and the Internet may be the deciding factor when denying the payment service. If the card holder is verified then a receipt or message 308 may be sent to the payment device 204.

The web services 206 may be any type of Internet based social service such as, but not limited to, Facebook, Linked In, Google+ who provide a service where the user (in this case the card holder) need to create a password protected user profile account that consist of personal data. The personal data in the user profile account may, when actively used, contain information about the user such as, but not limited to name, address, images, links to friends, home city, messages, etc. If the card holder is logged into the payment provider service through a web service account (or agrees to let the payment provider access a web service using the card holders credentials (such as Facebook, Linked In, Open ID or any other well known identity service's account credentials available on-line) information about the user may be retrieved, analyzed and used to determine if the profile, and thus the person behind the name, is a legit person or not. One way of determining if the profile belongs to a legit person or not is by checking parameters such as recent and old user and friend activity, posting of status messages, availability of photos, personal information about home city, educational background that can be compared to other social services.

In an embodiment of the present invention the analysis of the activity information of the profile may for instance examine time information (i.e. the time stamp) regarding when for instance a photo, a friend, an address, a background description, status updates, marital status etc have been added or updated in the user profile. The time stamps may be compared between different web services 206 where the user can be identified and/or have an account. Discrepancies in the activity information between the different web services 206 are detected and stored in the payment server 205. Primarily the analysis of the activity information aims to detect if the account activity is very recent and may have been carried out with the purpose to create a false user identity. The system may detect if the discrepancies are greater than a certain time period such as days, months or even years between the different items. The time discrepancies are analyzed and stored in the payment server 205 and may be used as an indication of the creation of a false user identity.

Activity information about the cardholder's friend's activity may also be gathered and compared if the web service provides this feature. In that case the number of friends is detected, and for instance when the friend relationships on the web service were established.

Photos of the card holder and his/hers friends may also be retrieved and stored for automatic image comparison, face recognition and analysis. Discrepancies in the imagery may be used as an indication of the creation of a false user identity.

With the current reliability of the web services, no source alone is used as the indication of an intentional creation of a false user identity (to 100%), but the use of several web service 206 sources of data may be considered to be enough to indicate potential fraud. When the sources of data increase in reliability, the way the data is weighted, when detecting potential fraud, may be altered from indicating potential fraud resulting in a recommendation from the payment server 205 to block the card holder, to actually detecting fraud and automatically blocking the card holder from using the payment system 200 and/or the payment card 201.

In this way web services 206 could, if used properly, provide evidence that the customer is a real physical person and not a fictive “person” setup as a front to commit fraud.

The detection of fraud could preferably be shared with other payment providers to quickly block the merchant from being able to use the payment service or a potentially stolen credit card elsewhere.

The KYC verification process above may be use only once when the payment device is new and needs to be setup, or it could be used repeatedly (in a regular or non-regular fashion) to further strengthen the security.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The foregoing has described the principles, preferred embodiments and modes of operation of the present invention. However, the invention should be regarded as illustrative rather than restrictive, and not as being limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the following claims.

1. A method for verifying an identity of a card holder associated with a payment card and using a payment device comprising a card reader and a mobile device that are communicatively coupled to each other, the method comprising the steps:
receiving card information from said mobile device with a payment server, the card information having been read by the card reader from the payment card and transmitted to the payment server by the mobile device as an initiation of card holder identity verification;
comparing, with the payment server, the received card information with stored card information in said payment server;
accessing, with the payment server, at least one web service located on one or more physical web servers connected to the Internet and where the card holder has created a password protected user profile account that comprises personal data of the card holder;
analyzing, with the payment server, account activity of the card holder's user profile account in said at least one web service;
verifying, with the payment server, that the identity of the card holder is the same as the identity associated with the payment card based on said analysis of information from said at least one web service and from said comparison of card information with stored card information; and
terminating said verification by communicating the result of the verification from said payment server to said payment device.

2. The method according to claim 1, further comprises the step of:
communicating an order for micropayment together with said card information from said mobile device to a payment server;
communicating said order for micropayment to a bank server;
verifying said order for micropayment in said bank server;
expediting said micropayment in said bank server; and
communicating a receipt and an account name to said payment server.

3. The method according to claim 2, further comprises the step of:
comparing the received account name with the stored card information in said payment server; and
basing said verification of identity of the card holder on said comparison of the received account name with the stored card information.

4. The method according to claim 1, further comprises the step of:
determining if said payment card is legit by reading card information, wherein if said reading fails the verifying is terminated.

5. The method according to claim 1, further comprises the step of:
encrypting said card information before communicating it to said payment server; and
decrypted said encrypted card information in said payment server.

6. The method according to claim 1, further comprises the step of:
encrypting said order for micropayment before communicating it to said payment server; and
decrypted said order for micropayment in said payment server or in said bank server.

7. The method according to claim 1, wherein said card information is the name of the card holder stored encrypted in said payment card.

8. The method according to claim 1, wherein said card information is pre-stored in said payment server from a previous verification or a registration from when the card holder firstly subscribed to the payment service offered by the payment provider.

9. The method according to claim 2, wherein said order for micropayment comprises at least an account number and amount.

10. The method according to claim 1, further comprises the step of:
communicating a receipt to said payment device sating if said card holders identity is determined to verified or not.

11. (canceled)

12. The method according to claim 1, wherein the web service is a social media website.

13. The method according to claim 12, wherein the account activity is one of social media friend activity, posting of a status message or status update, presence of a photo, listing of personal information about the card holder, or combinations thereof.
